(19) United States
(12) Patent Application Publication
(10) Pub. No.: US 2024/0381916 A1
(43) Pub. Date: Nov. 21, 2024

(54) METHOD FOR PRODUCING VEGETABLES AND FRUITS HIGHLY INFILTRATED WITH WATER-SOLUBLE ACTIVE INGREDIENTS

(71) Applicant: In Ho OH, Suweon-si, Gyeonggi-Do (KR)

(72) Inventor: In Ho OH, Suweon-si, Gyeonggi-Do (KR)

(21) Appl. No.: 18/575,817

(22) PCT Filed: Jun. 22, 2021
(86) PCT No.: PCT/KR2021/007783

§ 371 Date: Dec. 29, 2023

(51) Int. Cl. A23L 29/30; A23L 3/015; A23L 19/00; A23L 27/00

(52) U.S. Cl. CPC A23L 29/30; A23L 3/015; A23L 19/03; A23L 27/00

(57) ABSTRACT

The present inventive concept relates to a method for treating vegetables and fruits, wherein pressure is used to infiltrate the vegetables and fruits with water-soluble active ingredients so that a high concentration of a specific active ingredient is uniformly contained in a substrate inside the vegetables and fruits. The present inventive concept has the effect of making it possible to improve the sugar content in vegetables or fruits to at least 18 Brix.

### FIELD OF THE INVENTIVE CONCEPT

The present inventive concept relates to a method producing vegetables and fruits highly containing the water-soluble active ingredients, by using a low pressure to minimize the heat and phenomenon of the skin of the object to be processed and to infiltrate the object so that the water-soluble active ingredient can be evenly distributed in the flesh of the object.

### BACKGROUND OF THE INVENTIVE CONCEPT

Even after ripening vegetables and fruits after cultivation and harvest, the sugar content does not reach the high content expected by consumers, so there is a limit to increasing marketability.

In particular, tomatoes contain a large amount of citric acid, malic acid, succinic acid, amino acid, lutein, protein, sugar, ash, calcium, iron, phosphorus, vitamin A, vitamin B1, vitamin B2, vitamin C, dietary fiber, etc. It is rich in antioxidants such as lycopene and beta-carotene. The red color of tomatoes is due to substances called ‘carotenoids’, especially ‘lycopene’. Red tomatoes contain 7-12 mg % of lycopene.

Lycopene is effective in preventing prostate cancer in men, breast cancer in women, and cancer of the digestive system. Lycopene plays a role in discharging toxic substances produced when alcohol is broken down, so it is good to drink tomato juice before drinking alcohol or eat tomatoes as a side dish when drinking. Tomatoes are high in vitamin K, which prevents calcium from escaping and helps prevent osteoporosis or senile dementia. In addition, vitamin C contained in tomatoes gives elasticity to the skin, prevents fine wrinkles, and prevents melanin pigment from forming, which is effective in preventing melasma. In addition, the potassium contained in tomatoes helps to prevent high blood pressure caused by the salty eating habits of Koreans by discharging salt from the body out of the body.

Tomatoes are also perfect for a diet. The calories of one tomato (200 g) is only 35 kcal, and it has a lot of moisture and dietary fiber, so it gives a feeling of fullness. Therefore, if you eat one tomato before a meal, you can reduce the amount of food, and it also helps digestion and promotes metabolism. Therefore, it is suitable for obese and diabetic patients. When you eat greasy food, adding tomatoes promotes digestion, lightens the burden on the stomach, and neutralizes acidic foods. It is also rich in pectin (dietary fiber), which helps prevent constipation. On the other hand, tomato juice is good as a drink for patients because it contains less organic acid, less stimulation, excellent nutritional value, and good digestion.

However, likes and dislikes are divided compared to the components beneficial to the health of tomatoes, because the sugar content of tomatoes is not high, so there is a lack of replacing the sweetness of fruits. Efforts have been made to improve sugar content by improving conventional tomato varieties, but there is a limit to improving sugar content.

In addition, in the past, pickling was used to increase the sugar content or salinity of fruits and vegetables, but when agricultural products are pickled in a solution in which sugar or salt is dissolved, the prototype of the agricultural products is transformed due to the separation of protoplasts by osmosis, There was also a limit to distribution in a fresh state by increasing the sugar or salinity.

As a technology for increasing the sugar content of fruits and vegetables, a technology using a pressure difference is disclosed in Korean Patent Registration No. 10-1492889. A method of increasing sugar content by processing agricultural products in a reverse osmosis method while repeatedly performing pressurization and decompression has been disclosed. This is the principle that when the solution is sprayed while repeatedly performing pressurization and decompression, the solution adsorbed on the surface of the agricultural products is absorbed into the agricultural products by the reverse osmosis method. When this is done, the mist gathers into water droplets and flows down by gravity, so the mist of the solution to be adsorbed on the round agricultural products remains only in the bottom part, which has the fatal disadvantage of adsorbing the solution that has flowed down to the lower layer. It has to be penetrated, but there is a limit that it is difficult to put into practical use.

In addition, according to the prior art of the principle of repeatedly pressurizing and depressurizing to open the cell wall and allow the solution to be adsorbed into the inside of agricultural products little by little, it takes more than 30 minutes for processing time to repeat pressurization and decompression, so that it is weak to moisture and the meat quality is poor. There is a disadvantage that the shelf life of soft agricultural products is significantly reduced. Furthermore, the principle of repeating pressurization and decompression is to raise the atmospheric pressure inside the chamber to a certain level through pressurization, maintain the pressure, and then lower the pressure while discharging air again. The cycle of repeating pressurization and decompression is not constant. There is a disadvantage that the level of absorption of the solution is not constant.

The present inventive concept was completed in an effort to find a method capable of permeating a predetermined active ingredient without disturbing the original form even in the case of vegetables or fruits that are somewhat soft due to their high water content.

### DETAILED DESCRIPTION

### [Objects of the Inventive Concept]

An object of the present inventive concept is to provide a method for processing by infiltrating a specific active ingredient into fruits and vegetables in a short time.

In addition, an object of the present inventive concept is to ensure that active ingredients are evenly distributed in target fruits and vegetables by additionally applying vibration.

An object of the present inventive concept is to provide a treatment method for evenly strengthening a specific active ingredient in the flesh of a fruit or vegetable with soft flesh.

### [Inventive Method]

In order to achieve the above object, the present inventive concept provides a method for producing vegetables or fruits enriched with active ingredients, characterized in that the active ingredients in the solvent penetrate into the fruit or vegetables through the stem portion, comprising:

after completely immersing the fruit or vegetable in the tap in the solution in which the water-soluble active ingredient is dissolved,

putting it in the airtight unit in the pressurized chamber,

closing the lid to seal it,

pressurizing the internal air pressure to 1.2-1.8 atm and maintain it for 10-15 minutes.

In addition, the present inventive concept may further include applying vibration for 20 minutes so that the penetrated active ingredient is evenly distributed in the target fruit or vegetable.

More specifically, in order to evenly distribute the penetrating material in the object, fruit or vegetable, after pressurization is maintained at 1.4 atm for around 15 minutes to allow the active ingredient to penetrate through the tap of the fruit or vegetable, the process of increasing and lowering the pressure from 1.3 atm to 1.5 atm at intervals of 0.5 to 1 seconds is repeated for 20 minutes to generate waves in the solution and cause vibrations in the object by the force of the waves so that the infiltrate inside the object diffuses into the substrate inside the object.

### [Effect of The Inventive Concept]

According to the present inventive concept, fruits and vegetables enriched with various useful components can be manufactured without changing the original form, thereby contributing to the diversity of agricultural products and increasing consumption of agricultural products in response to the demand for various vegetables and fruits.

### BRIEF DESCRIPTION OF THE DRAWINGS

FIG. 1 is a result of observing changes in the appearance of cherry tomatoes by varying the pressure and pressurization time.

### EMBODIMENTS OF THE INVENTIVE CONCEPT

After completely immersing the fruit or vegetable with a tap in the solution in which the water-soluble active ingredient is dissolved, put it in the airtight unit in the pressurized chamber, close the lid to seal it, pressurize the internal air pressure to 1.2-1.8 atm and maintain it for 10-15 minutes. It provides a method for producing vegetables or fruits enriched with active ingredients, characterized in that the active ingredients in the solvent penetrate into the fruit or vegetables through the stem portion.

Additionally, after maintaining the pressure, the process of increasing and lowering the pressure in the range of 1.3 atm to 1.5 atm at intervals of 0.5 to 1 second is repeated for 20 minutes. More specifically, a cycle of lowering to 1.3atm and maintaining for 0.5 seconds and then raising to 1.5atm and maintaining for 0.5 seconds is repeated for 20 minutes to induce waves in the solution in which the object is immersed.

In the present inventive concept, various substances including sugar, salt, sucralose, stevioside, saponin, minerals or vitamins may be used as the water-soluble active ingredient.

In a preferred embodiment of the present inventive concept, the vegetable or fruit with stem is tomato or paprika, and as the water-soluble active ingredient, it is most preferable to mix stevioside with sucralose in a small amount or in a weight ratio of 3-4:1.

In the present inventive concept, the principle in which components in the solution are adsorbed to vegetables or fruits is that the solution pressurized in the pressure chamber pushes the solution through the stem, which is the part where the cell wall pressure of the immersed vegetable or fruit is the weakest, and the phenomenon is similar to pickling. This is the principle that the active ingredient in the solution penetrates into the inside of the vegetable or fruit in high concentration. It is understood that active ingredients such as permeated sugar are diffused by moisture contained in vegetables or fruits through a subsequent process of causing vibration so that the active ingredients are evenly contained throughout the fruit.

Accordingly, the pressure of the chamber capable of pushing the solute in the solution into the tap part is pressurized at 1.2-1.8 atm and maintained for 10-30 minutes, thereby preventing the absorption of additional moisture, that is, the solvent, and inducing only the absorption of the active ingredient, that is, the solute. Or, it is a condition for maximally infiltrating the active ingredient while maintaining the original shape of the vegetable. The pressure and time inside the chamber may be determined differently according to the type of target vegetable or fruit and the type of solute so that the active ingredient penetrated into the stem part can be evenly diffused into the substrate inside the fruit or vegetable.

The chamber pressure is based on the case where the external atmospheric pressure is 1 atm. It is most preferable to set the chamber pressure 0.2-0.8 atm higher than the external atmospheric pressure. In the case of applying a higher pressure than that, crackings of the vegetable or fruit skin appear.

According to the present inventive concept, in the case of tomatoes, it was confirmed that the penetration of the active ingredient was made in the part where the vascular bundle of the stem, which is the connection between the xylem and the sieve tube for connecting the tomato stem and fruit, is the weakest part.

The pressurization device of the present inventive concept includes a chamber, a chamber container for containing the contents, a sealing unit in which air inflow and outflow is controlled when the contents of the chamber container are pushed into the chamber and the lid is closed, an air inlet for injecting air into the chamber through a compressor, an air outlet that discharges air after it is finished, a pressure gauge that displays the air pressure inside the chamber, and a compressor as a device that injects air into the chamber.

When tomatoes are used as a material, there was a limit that it is difficult to increase the sugar content to about 8 brix or more through conventional breeding, but according to a preferred embodiment of the present inventive concept, it is possible to improve the sugar content to 18 brix or more.

Furthermore, since sugar as the solute can cause obesity, when stevioside is used as a solute as a sugar content improving substance, it has a sweet taste that is characteristic of stevioside but is not absorbed by the body, so it can be consumed without worrying about obesity or diabetes. Stevioside is about 200 times sweeter than sugar, but it does not increase the absorption of sugar in the body, so the sugar content is not measured at 18 Brix, but it can produce the same sweetness as 18 Brix when sugar is used.

However, it has been reported that a bitter taste can be felt at the end when sweetness is obtained with only stevioside, so in the present inventive concept, most preferably, stevioside and sucralose are mixed at a weight ratio of 3-4:1 to obtain optimal sweetness.

The present inventive concept is described by the following examples, but the scope of the present inventive concept is not limited by the examples.

### Example 1: Preparation of High Sugar Content Jujube Cherry Tomatoes

After completely immersing 20 pieces of 20 g jujube cherry tomatoes in a solution of 3 g of stevioside and 1 g of scuralose in 1000 ml of purified water, put the immersed tomatoes in a chamber and pressurize the internal pressure to 1.4 atm. After maintaining the pressure for 20 minutes, the cycle of lowering to 1.3atm and holding for 0.5 seconds and then raising to 1.5atm and maintaining for 0.5 seconds was repeated for 20 minutes to vibrate, then air was discharged and the immersed tomatoes were taken out of the chamber. As a result of examining the sugar content of the prepared jujube cherry tomatoes, it was confirmed that they produced a sweet taste corresponding to an average of 18 Brix.

### Example 2: Preparation of High Sugar Content Paprika

After completely immersing 6 pieces of 15 g paprika in a solution of 3 g of stevioside and 1 g of sucralose in 1000 ml of purified water, put the immersed paprika into the chamber, pressurize the internal pressure to 1.8 atm, maintain the pressure for 10 minutes, and then remove the air. The drained and soaked paprika was taken out of the chamber. As a result of examining the sugar content of the prepared paprika, it was equal to the sweetness corresponding to 20 brix.

Experimental Example 1: Change in Tomato Appearance According to Pressure and Time

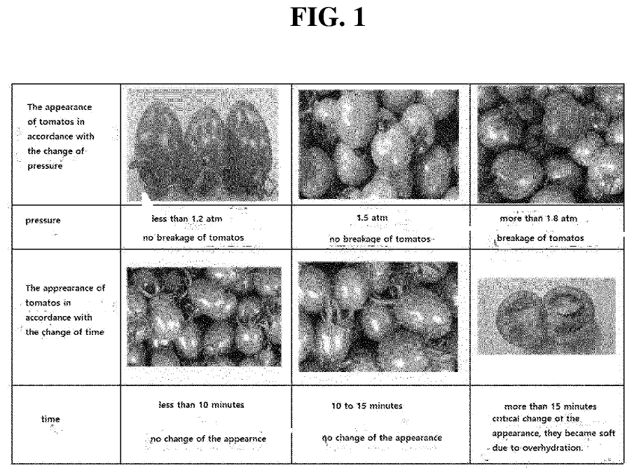

The result of observing the appearance of cherry tomatoes after pressurizing in the same way as in Example 1 at 1 atm, 1.4 atm, and 2 atm, and pressurizing time under the same pressure (1.4 atm) for 5 minutes, 15 minutes, and 20 minutes However, after pressing in the same manner as in Example 1, the results of comparing the results of observing the tomato appearance were the same as in FIG. 1.

The results of examining the sugar content of each tomato are shown in Tables 1 and 2 below:

TABLE 1

| pressure | 1 atm | 1.4 atm | 2 atm |
|---|---|---|---|
| Tomato sensory sugar level | 5 bricks | 18 bricks | 32 Briggs |

TABLE 2

| hour | 5 minutes | 15 minutes | 20 minutes |
|---|---|---|---|
| Tomato sensory sugar level | 12 bricks | 18 bricks | 25 bricks |

As a result, when pressurized at 1.4 atm for 15 minutes, in terms of appearance or sugar content, there is little change in appearance and you can feel the sweetness of about 18 brix, which consumers feel is the sweetest. Rather, it causes a bitter taste, so the most ideal time is around 15 minutes.

### Experimental Example 2: Sensory Evaluation of Tomatoes of the Present Inventive Concept

Based on 3 items, the aroma, taste, and overall preference of the conventionally distributed jujube cherry tomatoes (control group) and the cherry tomatoes according to Example 1 (experimental group) were evaluated by 10 men and women in their 20s and 30s and 15 people in their 40s or older. It was indicated using a point scale (1: very bad, 2: bad, 3: average, 4: good, 5: very good), and the results showed the average sum of each evaluation item (Table 3).

| division | | | Average |
|---|---|---|---|
| taste | 20-30's | experimental group | 4.2 |
| | | control group | 2.6 |
| | 40+ | experimental group | 3.9 |
| | | control group | 3.1 |
| incense | 20-30's | experimental group | 3.3 |
| | | control group | 3.0 |
| | 40+ | experimental group | 3.2 |
| | | control group | 2.9 |
| entire | 20-30's | experimental group | 4.0 |
| | | control group | 3.0 |
| | 40+ | experimental group | 3.9 |
| | | control group | 3.0 |

### Experimental Example 3: Confirmation of the Path through which the Active Ingredient is Injected into the Tomato

Tomatoes (experimental group) wrapped in plastic wrap except for the stems and tomatoes (control group) treated by siliconizing only the stems to block contact with the outside were treated with 3 g of stevioside and scuralose 1 g was completely immersed in a solution dissolved in 1000 ml of purified water, treated under the same conditions as in Example 1, and then the sugar content was measured. The results are shown in the table below.

TABLE 4

| division | experimental group | control group |
|---|---|---|
| perceived sweetness | 18 bricks | 5 bricks |

The purpose of the experiment is to show that the part where the active ingredient is adsorbed to the tomato is not the epidermal part, but the tap part where the fruit (tomato) nutrient and moisture passage connected to the stem part. It cannot be confirmed the hypothesis in the previous patent, that the active ingredient adsorbed part using the difference in pressure is the stomata of the fruit.

According to the present inventive concept, fruits and vegetables enriched with various useful components can be manufactured without changing the original form, thereby contributing to the diversity of agricultural products and increasing consumption of agricultural products in response to the demand for various vegetables and fruits.

1. A method for producing vegetables or fruits enriched with active ingredients, characterized in that after completely immersing the fruit or vegetable in the tap in the solution in which the water-soluble active ingredient is dissolved,
put it in the airtight unit in the pressure chamber, close the lid, pressurize the internal air pressure to 1.2-1.8 atm,
and maintain it for 10-15 minutes. the active ingredients in the solvent penetrate into the fruit or vegetables through the stem portion.

2. After maintaining the pressure in claim 1, the method further comprises the step of increasing and lowering the pressure in the interval of 1.3 atm to 1.5 atm at intervals of 0.5 to 1 second for 20 minutes.

3. In claim 1, the water-soluble active ingredient is sugar, salt, sucralose, stevioside, saponin, minerals or vitamins.

4. In claim 1, the vegetable or fruit with stem is tomato or paprika, and the water-soluble active ingredient is characterized in that stevioside and sucralose are mixed in a weight ratio of 3-4:1
